(19) United States
(12) Patent Application Publication
(10) Pub. No.: US 2023/0398729 A1
(43) Pub. Date: Dec. 14, 2023

(54) PROGRAMMABLE METAMATERIAL AND METHOD OF CONTROLLING MACROSCOPIC PROPERTIES OF A METAMATERIAL

(71) Applicant: President and Fellows of Harvard College, Cambridge, MA (US)

(72) Inventors: Jochen MUELLER, Baltimore, MD (US); Jennifer A. LEWIS, Cambridge, MA (US); Katia BERTOLDI, Cambridge, MA (US)

(73) Assignee: President and Fellows of Harvard College, Cambridge, MA (US)

(21) Appl. No.: 18/034,756

(22) PCT Filed: Nov. 11, 2021
(86) PCT No.: PCT/US2021/058942

§ 371 Date: May 1, 2023

Related U.S. Application Data
(60) Provisional application No. 63/113,312, filed on Nov. 13, 2020.

(51) Int. Cl. B29C 64/118; B33Y 70/00; B33Y 80/00

(52) U.S. Cl. CPC B29C 64/118; B33Y 70/00; B33Y 80/00

(57) ABSTRACT

A method of controlling macroscopic properties of a metamaterial includes 3D printing a lattice structure comprising interconnected struts, where each strut comprises one or more printed filaments. Each printed filament comprises an active material or a passive material, and the active material has a modulus with a higher stimulus dependence than that of the passive material. The printed filaments comprising the active material are disposed at predetermined regions of the lattice structure. After 3D printing, the lattice structure is exposed to a stimulus, and the predetermined regions comprising the active material soften or stiffen. Thus, the macroscopic properties of the lattice structure may be controlled.

### RELATED APPLICATION(S)

The present patent document claims the benefit of priority under 35 U.S.C. 119(e) to U.S. Provisional Patent Application No. 63/113,312, which was filed on Nov. 13, 2020, and is hereby incorporated by reference in its entirety.

### FEDERALLY SPONSORED RESEARCH AND DEVELOPMENT

This invention was made with government support under W911NF-17-1-0147 awarded by the U.S. Army Research Office. The government has certain rights in the invention.

### TECHNICAL FIELD

The present disclosure is related generally to fabrication of lattice structures and more particularly to 3D printing of programmable metamaterials.

### BACKGROUND

From enhanced relative stiffness, strength, and toughness to thermal insulation and vibration control, lattice structures enable a wide range of properties that are largely defined by their architecture. However, these systems typically maintain these predetermined functions throughout their lifetimes, even when requirements may change. In an attempt to realize responsive structures, shape memory polymers have been introduced to achieve thermally tunable elastic moduli and Poisson's ratios as well as adjustable band gaps. Further, adaptive behavior has been demonstrated in lattices composed of hollow tubes filled with granular particles or magnetorheological fluid suspensions. However, the resulting structures either exhibit long actuation time, lack of reversibility, and/or possess higher structural complexity and cannot be fabricated monolithically.

### BRIEF SUMMARY

A programmable metamaterial includes a lattice structure comprising an active material and a passive material and having interconnected struts, where the active material has a modulus with a higher stimulus dependence than that of the passive material. The active material is disposed at predetermined regions of the lattice structure to enable softening or stiffening of the predetermined regions upon exposure to a stimulus.

A method of controlling macroscopic properties of a metamaterial includes 3D printing a lattice structure comprising interconnected struts, where each strut comprises one or more printed filaments. Each printed filament comprises an active material or a passive material, where the active material has a modulus with a higher stimulus dependence than that of the passive material. The printed filaments comprising the active material are disposed at predetermined regions of the lattice structure. After 3D printing, the lattice structure is exposed to a stimulus, and the predetermined regions comprising the active material soften or stiffen. Thus, the macroscopic properties of the lattice structure may be controlled.

### BRIEF DESCRIPTION OF THE DRAWINGS

FIGS. 1A and 1B are front-view and plan-view schematics, respectively, of an exemplary multimaterial lattice structure comprising an active material, which may soften or stiffen when exposed to a stimulus, and a passive material, whose mechanical response may be stimulus-independent.

FIG. 1C provides an exploded view of the lattice structure of FIGS. 1A and 1B, showing separately the arrangement of the active and passive materials.

FIG. 2A is a schematic of another exemplary multimaterial lattice structure comprising an active material and a passive material.

FIG. 2B provides an exploded view of the lattice structure of FIG. 2A, showing separately the arrangement of the active and passive materials.

FIG. 3A is a schematic of another exemplary multimaterial lattice structure comprising an active material and a passive material.

FIG. 3B provides an exploded view of the lattice structure of FIG. 3A, showing separately the arrangement of the active and passive materials.

FIG. 4A is a schematic of another exemplary multimaterial lattice structure comprising an active material and a passive material.

FIG. 4B provides an exploded view of the lattice structure of FIG. 4A, showing separately the arrangement of the active and passive materials.

FIG. 5A is a schematic of another exemplary multimaterial lattice structure comprising an active material and a passive material.

FIG. 5B provides an exploded view of the lattice structure of FIG. 5A, showing separately the arrangement of the active and passive materials.

FIG. 6 is a schematic of an exemplary 3D printing process (e.g., fused deposition modeling or FDM) to fabricate a multimaterial lattice structure.

FIG. 7A plots storage modulus versus temperature for an active material comprising polyethylene terephthalate (PET) and a passive material comprising polycarbonate (PC).

FIG. 7B plots stress versus strain for the active and passive materials of FIG. 7A at 23° C. and 100° C.

FIG. 8A shows effective stress versus strain at 23° C. and 100° C. for a single material lattice structure comprising the passive material. Experimental and computational (“FEA” for finite element analysis) data are shown.

FIG. 8B shows effective stress versus strain at 23° C. and 100° C. for a single material lattice structure comprising the active material. Experimental and computational data are shown.

FIG. 9A shows experimental stress-strain data for the multimaterial lattice structure of FIG. 3A, where γ=30°.

FIG. 9B shows the stress-strain response predicted by finite element analysis for the multimaterial lattice structure of FIG. 3A at T=23° C. and T=100° C. for γ=0°, 30°, and 90°.

FIGS. 9C-9D show numerically predicted deformation of the multimaterial lattice structure of FIG. 3A at T=100° C. for (γ, ε)=(90°, 25.4%), (30°, 12.6%), and (0°, 1.4%), respectively.

FIG. 10 shows experimental and computational stress-strain response at T=23° C. and T=100° C. for the multimaterial lattice structure shown in FIG. 2A.

FIGS. 11A and 11B show numerically predicted deformation of the multimaterial lattice structure of FIG. 2A for ε=2.8% at T=23° C. and T=100° C., respectively.

FIG. 12A illustrates how stiffness of a triangular lattice structure may be programmed at high temperature by varying the edge length of the triangular cells, l*, made out of the passive material, as shown for one example in FIGS. 2A and 2B.

FIG. 12B shows evolution of E* as a function of l*(see FIG. 12A) and relative density at T=100° C.

FIG. 13A is a schematic of another exemplary multimaterial lattice structure comprising an active material and a passive material.

FIG. 13B provides an exploded view of the lattice structure of FIG. 13A, showing separately the arrangement of the active and passive materials.

FIG. 14 shows experimental and computational stress-strain response at T=23° C. and T=100° C. for the multimaterial lattice structure shown in FIG. 13A.

FIGS. 15A and 15B show numerically predicted deformation of the multimaterial lattice structure of FIG. 13A for ε=12.6% at T=23° C. and T=100° C., respectively.

FIG. 16A is a schematic of another exemplary multimaterial lattice structure comprising an active material and a passive material.

FIG. 16B provides an exploded view of the lattice structure of FIG. 16A, showing separately the arrangement of the active and passive materials.

FIG. 17A shows experimental and computational stress-strain response at T=23° C. and T=100° C. for the multimaterial lattice structure shown in FIG. 16A.

FIGS. 17B and 17C show numerically predicted deformation of the multimaterial lattice structure of FIG. 16A for ε=30.8% at T=23° C. and T=100° C., respectively.

FIG. 18A shows experimental and computational stress-strain response at T=23° C. and T=100° C. for the multimaterial lattice structure shown in FIG. 1A.

FIGS. 18B and 18C show numerically predicted deformation of the multimaterial lattice structure of FIG. 1A for ε=14% at T=23° C. and T=100° C., respectively.

FIG. 19A shows numerically predicted evolution of the effective Poisson's ratio as a function of temperature for single-material lattice structures fabricated from PC, PET and for the multimaterial lattice structure shown in FIG. 4A.

FIGS. 19B and 19C show numerically predicted deformation of the multimaterial lattice structure of FIG. 4A for ε=4.2% at T=23° C. and T=100° C., respectively.

### DETAILED DESCRIPTION

Described in this disclosure is a new class of multimaterial lattice structures that can be monolithically fabricated by 3D printing and which may exhibit programmable properties (e.g., stiffness, Poisson's ratio, and/or deformation modes) in response to a stimulus. To achieve this goal, an active material that softens or stiffens upon exposure to a stimulus is combined with a passive material having nearly stimulus-independent properties over the experimental conditions explored. Guided by numerical analyses, it is demonstrated that the distribution of these two materials within the printed lattice structures can give rise to vastly different mechanical properties under predetermined conditions (e.g., elevated temperature), without altering the behavior under ambient conditions. The examples focus on triangular lattices with temperature as the stimulus; however, as described below, the strategy is readily extendible to other architectures and environmental stimuli, opening new avenues for the design and fabrication of adaptive safety and sports equipment, morphing aerospace structures, and reconfigurable soft robots. A programmable metamaterial and method of controlling properties of a metamaterial are described in detail below.

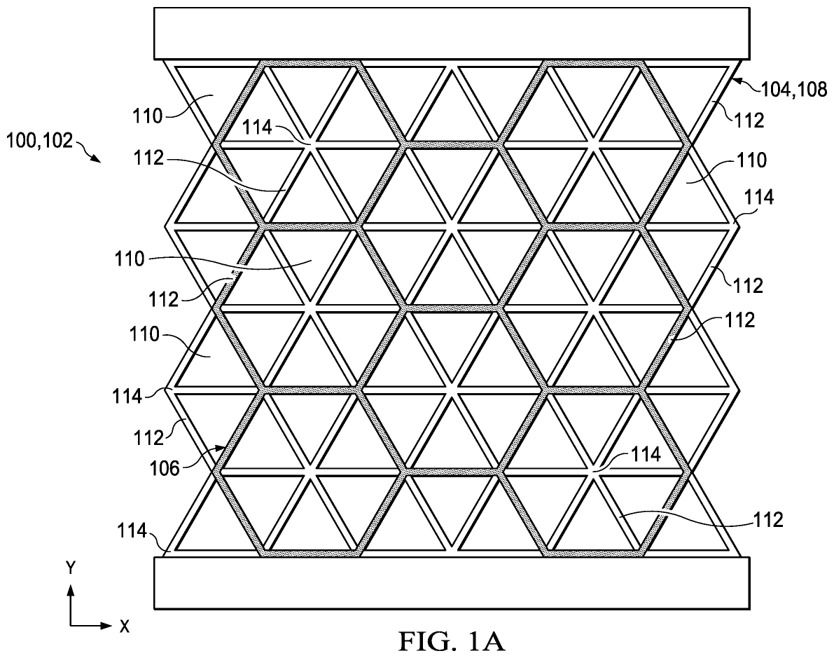

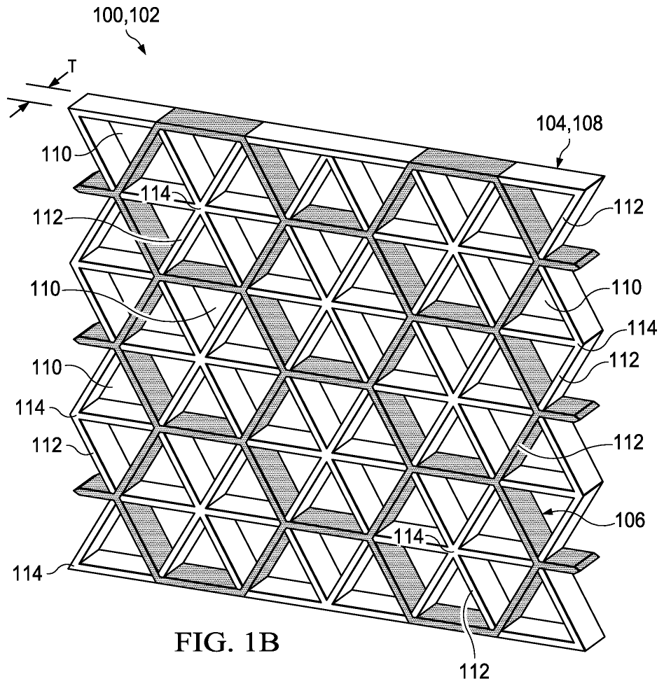

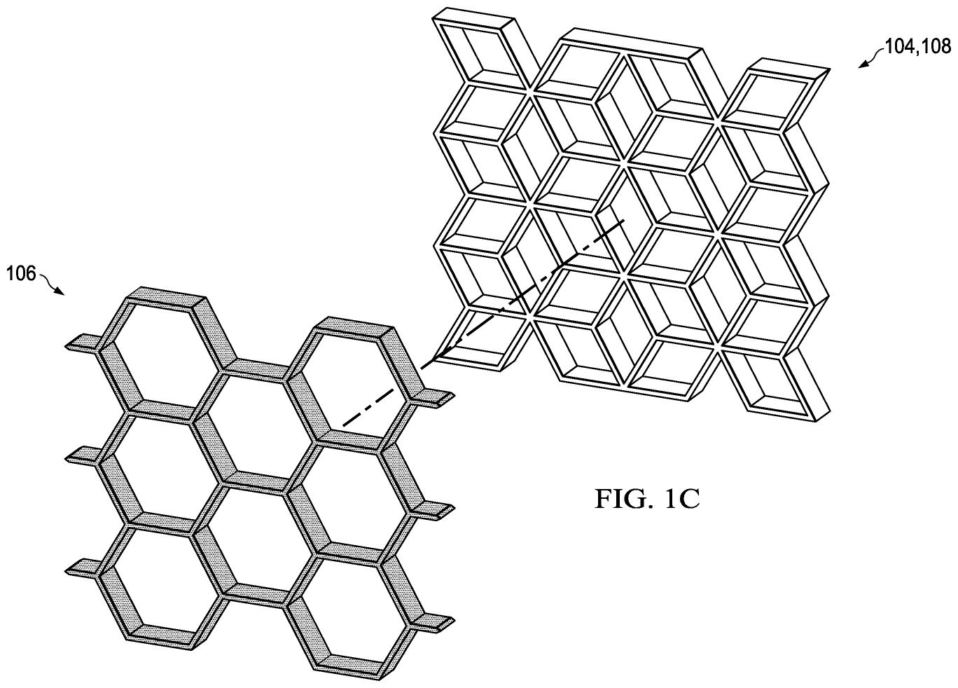

The programmable metamaterial 100 includes a multimaterial lattice structure 102 comprising interconnected struts 112, as illustrated for one exemplary geometry (a triangular lattice) in FIGS. 1A and 1B. The lattice structure 102 comprises an active material 104 and a passive material 106, where a modulus (e.g., elastic modulus or storage modulus) of the active material 104 has a higher stimulus dependence than the modulus of the passive material 106. In other words, the modulus (or “stiffness”) of the active material 104 exhibits a greater shift or change upon exposure to a stimulus (e.g., a change in temperature) compared to the modulus of the passive material 106. Consequently, the active material 104 softens or stiffens more than the passive material 106 when exposed to the stimulus. In some examples, the passive material 106 may not soften or stiffen at all; that is, the modulus of the passive material 106 may exhibit no shift or no change during the exposure. The stimulus may be a higher or lower temperature, a higher or lower intensity of light, a higher or lower amount of moisture, and/or an applied stress at an increased or a reduced strain rate, compared to an initial condition.

As illustrated in FIGS. 1A and 1B, the active material 104 is disposed at predetermined regions 108 of (i.e., arranged within) the lattice structure 102 to enable softening or stiffening of the predetermined regions 108 upon exposure to the stimulus. The predetermined regions 108 may include struts 112, portions of struts 112, and/or nodes 114 of the lattice structure 102. Similarly, the passive material 106 may be arranged to define a particular strut or unit cell geometry and/or to obtain certain properties after exposure to the stimulus. Accordingly, macroscopic properties of the lattice structure 102 may be controlled. The differing arrangements of the active and passive materials 104,106 within the lattice structure 102 may be visualized with the help of the exploded view provided in FIG. 1C. In this example, the passive material 106 is arranged to define a hexagonal unit cell.

Each strut 110 may be formed from one or more printed filaments, as described below in regard to the printing method of fabrication. The lattice structure 102 may be formed from multiple layers of printed filaments, such that the multiple layers define a thickness T of the lattice structure 102, as indicated in FIG. 1B. When viewed along a plane perpendicular to the thickness direction, the lattice structure 102 may comprise a 2D lattice such as a triangular lattice (as illustrated in FIG. 1A), a square lattice, a hexagonal lattice, a rectangular lattice, and/or an oblique lattice. Typically, as shown in FIGS. 1A and 1B, the lattice structure 102 includes voids 110 between the struts 112, such that the lattice structure 102 is a porous structure. In some examples, however, the lattice structure 102 may not include voids between the struts 112, and instead may be a solid structure.

Each of the active material 104 and the passive material 106 may comprise a polymer, metal, ceramic and/or semiconductor which preferably may be formulated as a 3D printable material or ink formulation. A suitable polymer may be a thermoplastic or a thermoset polymer. Examples of suitable polymers may include polyethylene terephthalate (PET), glycol-modified polyethylene terephthalate (PETG), polylactic acid (PLA), chlorinated polyethylene (CPE), polycarbonate (PC), and/or copolyester. For thermally-activated lattice structures where a change in temperature (e.g., heating) is employed as the stimulus, the passive material may have a higher glass transition temperature than the active material. In one example, the passive material may comprise polycarbonate (PC) and the active material may comprise polyethylene terephthalate (PET). The active material and/or the passive material 104,106 may include filler particles configured to alter the electrical, optical, magnetic and/or mechanical properties of the lattice structure 102. To promote structural integrity of the lattice structure 102, the selected active material 104 and the passive material 106 may be capable of adhering to each other. In some examples, the lattice structure 102 may further include an adhesive or binder to ensure adherence of the active and passive materials 104,106.

When the lattice structure 102 is exposed to the stimulus, the mechanical properties (e.g., stiffness, storage modulus, elastic modulus, yield strength, and/or failure strength) of the active and passive materials 104,106 may differ significantly. The stimulus may be selected such that the difference between one or more of the mechanical properties of the active and passive materials 104,106 is maximized.

In contrast, when the lattice structure 102 is at an initial condition (which may be room temperature (e.g., 18-25° C.) or another initial temperature, in darkness or under an initial intensity of light, in a dry state or comprising an initial amount of moisture, under no applied stress or under an applied stress at an initial strain rate), the mechanical properties of the active material and the passive material 104,106 may be the same or similar. Preferably, the active and passive materials 104,106 have mechanical properties as close as possible in the initial condition such that any lattice structure 102 comprising the active and passive materials 104,106 behaves similarly in the initial condition (e.g., at room temperature), independent of how the active and passive materials 104,106 are spatially arranged in the lattice structure 102. For example, in the initial condition, the storage modulus of the active material 104 may differ from the storage modulus of the passive material 106 by no more than +/−10%, the elastic modulus of the active material 104 may differ from the elastic modulus of the passive material 106 by no more than +/−10%, the yield strength of the active material 104 may differ from the yield strength of the passive material 106 by no more than +/−10%, and/or the failure strength of the active material 104 may differ from the failure strength of the passive material 106 by no more than +/−10%.

Referring for example to FIGS. 1A and 1B, in the initial condition, the active and passive materials 104,106 may have mechanical properties as described above such that the predetermined regions 108 comprising the active material 104 behave similarly to or the same as the rest of the lattice structure 102. Consequently, an applied load (which may be applied normal to one or both ends of the lattice structure 102) may be homogeneously distributed throughout the triangular lattice and absorbed by both the active and passive materials 104,106. However, upon exposure to a stimulus that induces softening or stiffening of the predetermined regions 108, the load may instead be absorbed primarily or exclusively by the passive material 106 (in the case of softening) or the active material 104 (in the case of stiffening), such that the lattice structure no longer behaves as a triangular lattice. Predetermined regions 108 that undergo softening may be understood to be deactivated within the lattice structure 102. In other words, predetermined regions 108 of the lattice structure 102 that have undergone softening may be ineffective in supporting an applied load and/or unable to maintain their structural integrity under an applied load. If, on the other hand, the predetermined regions 108 stiffen in response to the stimulus, then (other) regions of the lattice structure 102 comprising the passive material 106 may be deactivated.

In one particular example in which a change in temperature is the stimulus, the active material 104 and the passive material 106 may have different glass transition temperatures (T_{g}). For example, the active material 104 may have a glass transition temperature lower than that of the passive material 106, and softening of the predetermined regions 108 may occur upon exposure to a temperature that lies between the glass transition temperatures of the active and passive materials 104,106. Advantageously, such a temperature may induce softening and deactivation of predetermined regions 108 comprising the active material 104 and no change or substantially no change in the passive material 106.

Accordingly, at the temperature between the glass transition temperatures, mechanical properties (e.g., stiffness, storage modulus, elastic modulus, yield strength, and/or failure strength) of the active and passive materials 104,106 may differ significantly. More specifically, the temperature between the glass transition temperatures may be selected such that the difference between one or more of the mechanical properties of the active and passive materials 104,106 may be maximized. For example, at the (selected) temperature between the glass transition temperatures of the active and passive materials 104,106, the difference between a storage modulus of the active material 104 and a storage modulus of the passive material 106 may be a maximum. Also or alternatively, at the temperature between the glass transition temperatures of the active and passive materials 104,106, the storage modulus of the passive material 106 may be at least one order of magnitude, at least 1.5 orders of magnitude, and/or at least two orders of magnitude greater than the storage modulus of the active material 104. It is also contemplated that, at a temperature higher than the glass transition temperatures of the active and passive materials 104,106, a storage modulus of the active material 104 may be higher than that of the passive material 106.

In contrast, at room temperature (e.g., 18-25° C.), or at another temperature below the glass transition temperatures of both the active and the passive materials 104,106, the mechanical properties of the active material and the passive material 104,106 may be the same or similar. Preferably, the active and passive materials 104,106 have mechanical properties as close as possible at ambient conditions (e.g., room temperature and/or atmospheric pressure) such that any lattice structure 102 comprising the active and passive materials behaves similarly under these conditions, independent of how the active and passive materials 104,106 are spatially arranged in the lattice structure 102. For example, at room temperature the storage modulus of the active material 104 may differ from the storage modulus of the passive material 106 by no more than +/−10%, the elastic modulus of the active material 104 may differ from the elastic modulus of the passive material 106 by no more than +/−10%, the yield strength of the active material 104 may differ from the yield strength of the passive material 106 by no more than +/−10%, and/or the failure strength of the active material 104 differs from the failure strength of the passive material 106 by no more than +/−10%.

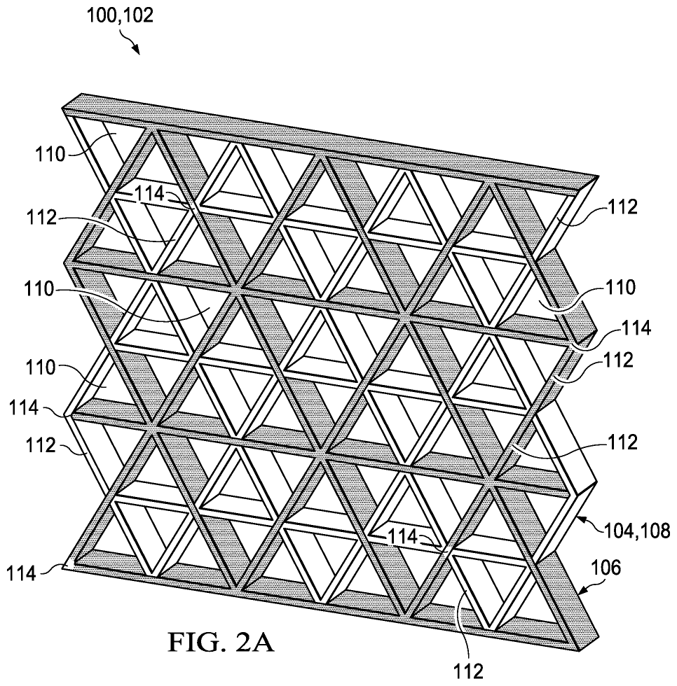

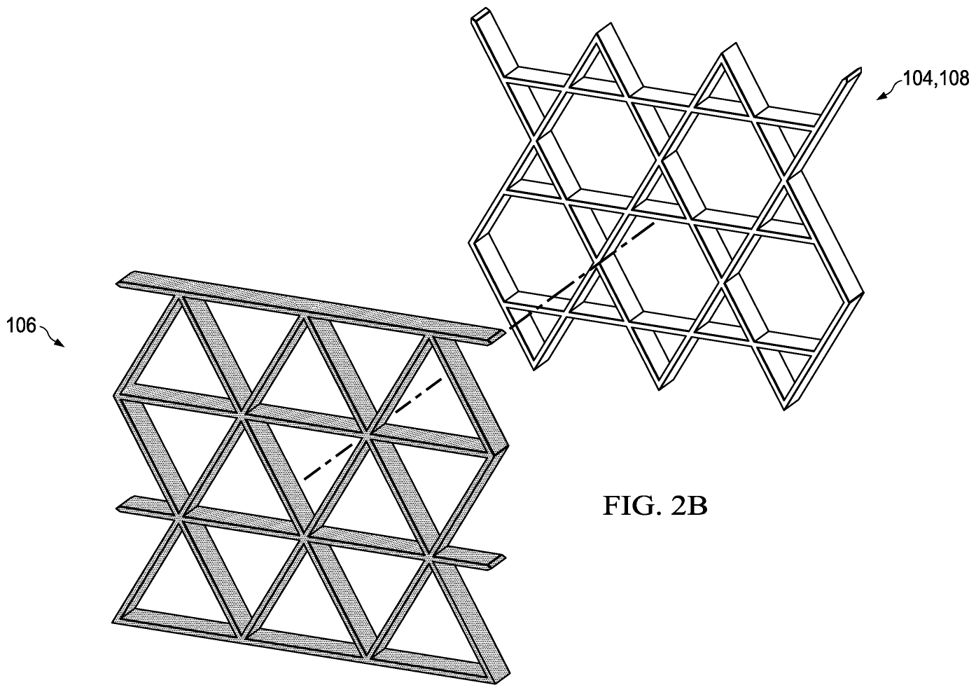

The arrangement of the active and passive materials 104,106 may be designed or selected to alter the mechanical properties of the lattice structure 102 in a controlled manner. For example, the lattice structure 102 may comprise a first unit cell (size and/or geometry) at an initial condition, and, due to the softening or stiffening of the predetermined regions 108 that occurs when exposed to the stimulus, the lattice structure 102 may have a second effective unit cell (size and/or geometry) upon exposure to the stimulus. This change can be visualized in reference to FIG. 1A, which shows a first unit cell based on triangles of the triangular lattice. Upon exposure to a stimulus that induces softening of the predetermined regions 108 comprising the active material 104, the second effective unit cell is based on hexagons defined by the arrangement of the passive material 106. In an example where the stimulus is a change of temperature, the softening may occur at a temperature between the glass transition temperatures of the active and passive materials 104,106, as discussed above. Similarly, FIG. 2A shows a lattice structure 102 comprising a first unit cell size based on triangles of the triangular lattice, and a second effective unit cell size based on larger triangles defined by the arrangement of the passive material 106 after the predetermined regions 108 comprising the active material 104 undergo softening and deactivation, as shown in FIG. 2B.

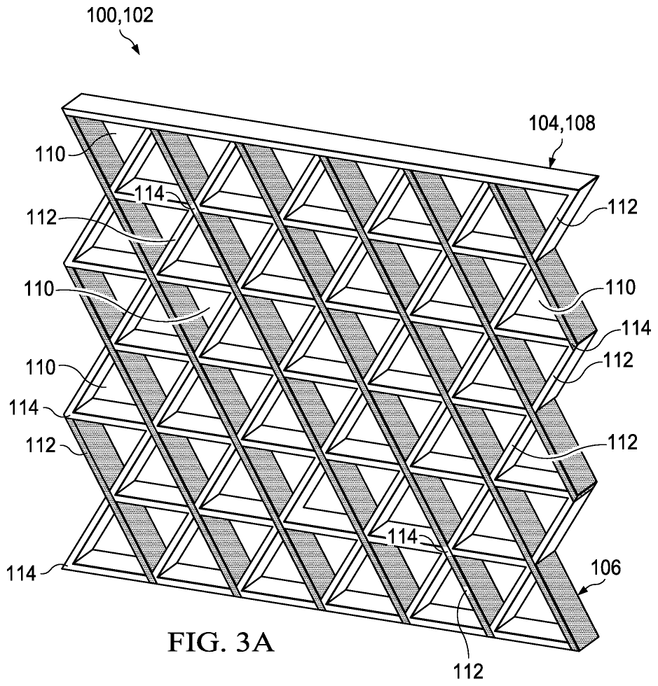

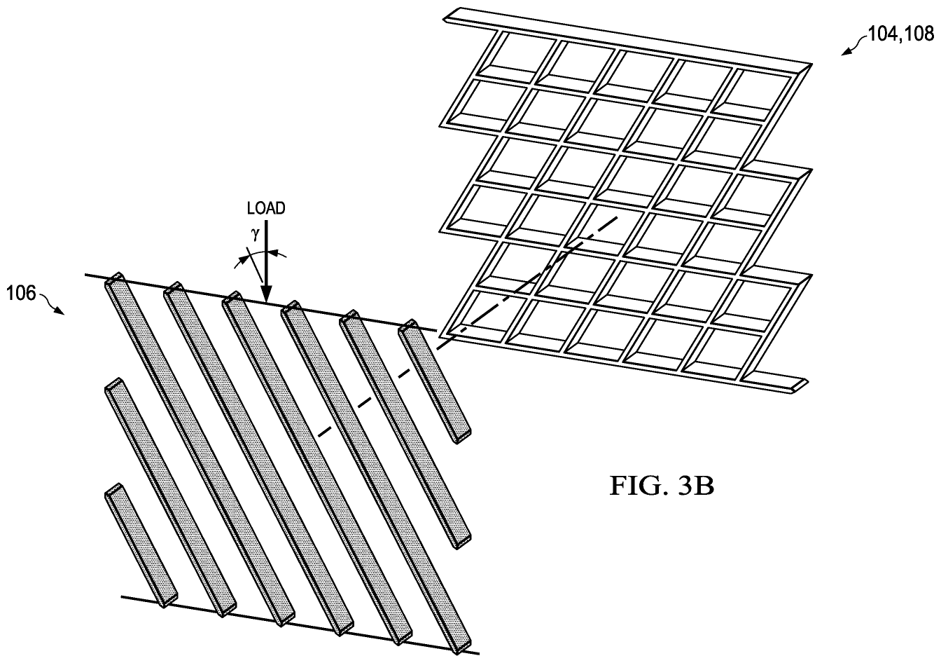

In another example, the lattice structure 102 may comprise isotropic properties at an initial condition and anisotropic properties upon exposure to the stimulus due to the softening or stiffening of the predetermined regions 108. This can be visualized in reference to FIGS. 3A and 3B. FIG. 3A shows an isotropic lattice structure (in this example, a triangular lattice) that includes active and passive materials 104,106 having similar or the same mechanical properties, such that the lattice structure comprises isotropic properties in the initial condition. Upon exposure to a stimulus that induces softening of the predetermined regions 108 that comprise the active material 104, the lattice structure 102 effectively transforms to an anisotropic structure that exhibits anisotropic properties, given the spatial arrangement of the passive material 106, as illustrated in FIG. 3B. In an example where the stimulus is a change of temperature, the softening may occur at a temperature between the glass transition temperatures of the active and passive materials 104,106.

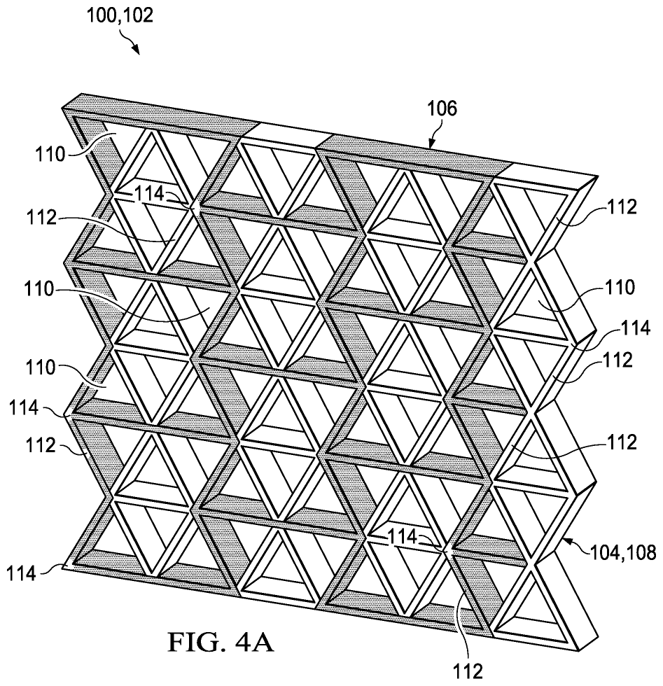

In yet another example, the lattice structure 102 may comprise a positive Poisson's ratio at an initial condition and a negative Poisson's ratio upon exposure to the stimulus, due to the softening or stiffening of the predetermined regions 108 comprising the active material 104. A structure having a positive or conventional Poisson's ratio may exhibit contraction in a direction perpendicular to an applied tensile load; whereas a structure having a negative Poisson's ratio may exhibit expansion in a direction perpendicular to an applied tensile load. Referring to FIG. 4A, in the initial condition, the lattice structure 102 of this example comprises a triangular lattice with active and passive materials 104,106 having similar or the same mechanical properties. Upon exposure to a stimulus that induces softening of the predetermined regions 108, the behavior of the lattice structure 102 is governed by the arrangement of the passive material 106, as shown in FIG. 4B, which absorbs most or all of any applied load and is configured to exhibit a negative Poisson's ratio. In an example where the stimulus is a change of temperature, the softening may occur at a temperature between the glass transition temperatures of the active and passive materials 104,106.

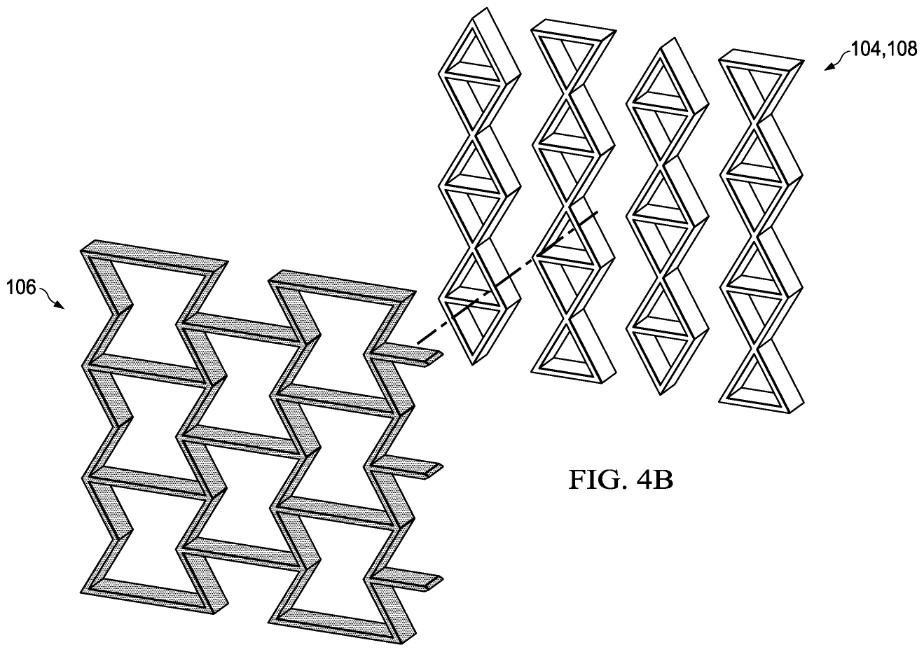

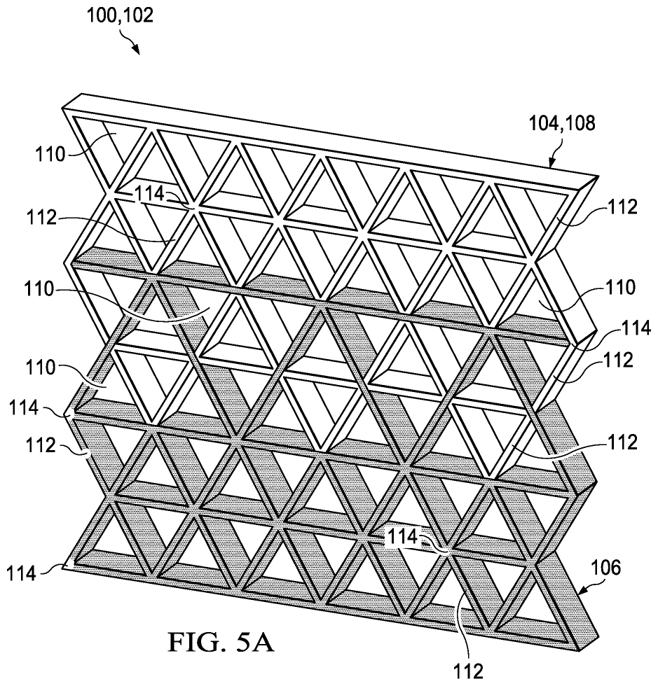

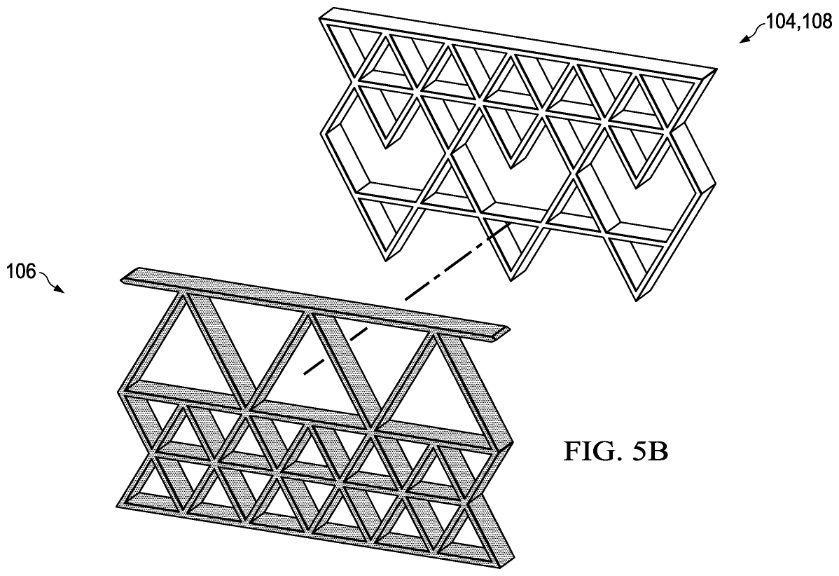

It is also contemplated that the lattice structure 102 may exhibit spatially uniform properties at an initial condition and a gradient in properties, or spatially nonuniform properties, upon exposure to the stimulus, again due to the softening or stiffening of the predetermined regions 108 comprising the active material 104. Referring to FIG. 5A, in the initial condition, the lattice structure 102 of this example comprises a triangular lattice with active and passive materials 104,106 having similar or the same mechanical properties. The predetermined regions 108 soften when exposed to the stimulus, leading to an effective gradual change in the support structure moving from top to bottom of the lattice structure 102, as shown in FIG. 5B, due to the arrangement of the passive material 106. Consequently, the lattice structure 102 may exhibit a gradient in mechanical properties (and/or spatially nonuniform mechanical properties) when exposed to the stimulus. In an example where the stimulus is a change of temperature, the softening may occur at a temperature between the glass transition temperatures of the active and passive materials 104,106.

In a final example, the lattice structure 102 may comprise a first deformation mode, such as a stretching-dominated deformation mode, at an initial condition, and a second deformation mode, such as a bending-dominated deformation mode, upon exposure to the stimulus. Stretching-dominated structures may be characterized by high stiffness and strength, and bending-dominated structures may have low transmitted (peak) stress and high toughness, making them suitable for energy-absorbing applications. This change in deformation mode may depend upon the connectivity number, Z, which refers to the average number of connections at joints or nodes of the lattice structure 102. The triangular lattice in the initial condition has a value of Z=6. It is recognized that for Z≥6, two-dimensional lattice structures tend to be stretching dominated, whereas for Z≤3, the lattice structures tend to be bending-dominated. Accordingly, this programmable transition in mechanical behavior may be achieved by arranging the passive material 106 to form hexagonal unit cells (Z=3), as illustrated in FIG. 1A. Upon exposure to the stimulus, the predetermined regions 108 comprising the active material 104 may be deactivated. In an example where the stimulus is a change of temperature, the softening of the predetermined regions 108 may occur at a temperature between the glass transition temperatures of the active and passive materials 104,106.

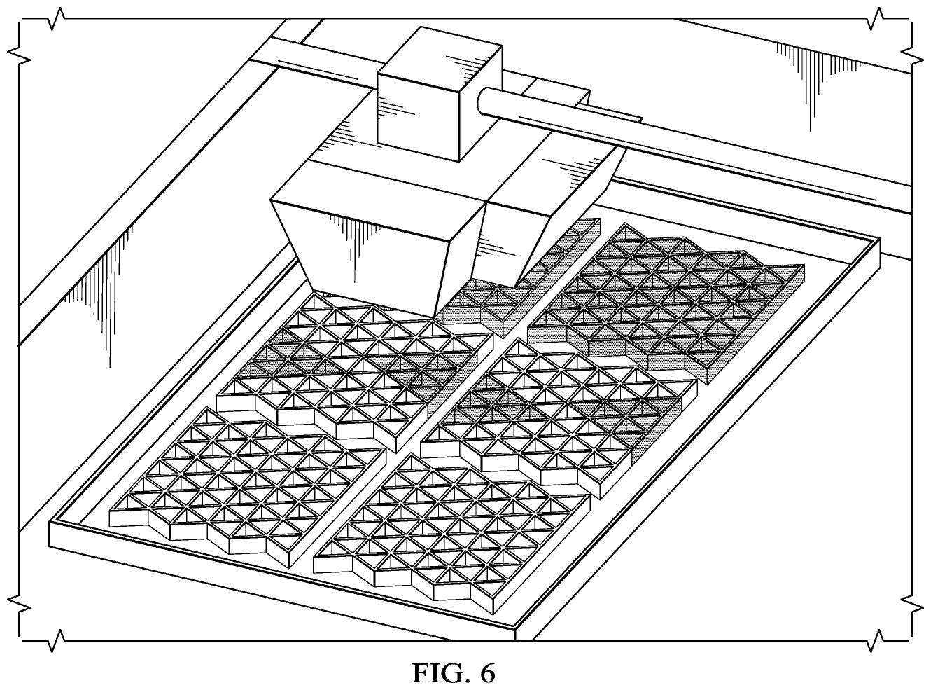

Referring to FIG. 6, the programmable metamaterial described above may be formed using an extrusion-based printing process, which may be referred to as 3D printing and/or fused deposition modeling (FDM). The method may include 3D printing a lattice structure comprising interconnected struts, where each strut comprises one or more printed filaments and each printed filament comprises an active material or a passive material. As explained above, the active material has a stiffness or modulus with a higher stimulus dependence than that of the passive material. The printed filaments comprising the active material are disposed at predetermined regions (e.g., struts, portions of struts, and/or nodes) of the lattice structure. 3D printing may comprise extruding and depositing the printed filaments onto a substrate, as shown in FIG. 6, in a layer-by-layer process.

Ink formulations suitable for 3D printing may be flowable and/or exhibit shear-thinning behavior. Advantageously, the ink formulations may be readily extruded through a deposition nozzle, which may be moved relative to the substrate to form a continuous printed filament. Typically, the deposition nozzle has an inner diameter in a range from about 0.1 mm to about 1 mm. The deposition nozzle can be moved at a constant or variable speed along a desired print path while the substrate remains stationary; alternatively, the substrate may be moved while the deposition nozzle remains stationary, or both the deposition nozzle and the substrate may be moved. In a typical 3D printing or FDM process, the deposition nozzle travels along a predetermined two-dimensional print path while extruding and depositing (“printing”) the printed filament on the substrate; after deposition of a first layer, the substrate may be retracted vertically away from the deposition nozzle (and/or the deposition nozzle may be raised vertically away from the substrate), such that the deposition process may be repeated to form a second layer, and so on. Multiple layers of the printed filaments may be deposited such that the multiple layers define the thickness T of the lattice structure. Print speeds in a range from 10 mm/s to 100 mm/s are typical. Preferably, the printed filament may substantially maintain its shape after deposition.

In some examples, 3D printing may be carried out at an elevated temperature, e.g., using a printing feedstock comprising a solid polymer which softens and/or melts at the elevated temperature, followed by cooling to room temperature upon deposition. For example, the deposition nozzle may be heated to the desired temperature (e.g., in a range from 220° C. to about 300° C.) for printing. The substrate onto which the printed filament is deposited may also or alternatively be heated (e.g., in a range from about 40-120° C.). The printed filaments comprising the active material may be extruded and deposited prior to the printed filaments comprising the passive material, e.g., when the passive material has a higher glass transition temperature. In other examples, 3D printing may be carried out at room temperature using a printing ink comprising a precursor material dissolved in a solvent, followed by evaporation of the solvent. 3D printing may also or alternatively include a post-extrusion and/or post-deposition curing or solidification step. Structural integrity of the lattice structure may be promoted by selecting active and passive materials that exhibit strong adhesion to each other upon co-printing and/or curing.

After 3D printing, the lattice structure may be exposed to a stimulus, whereby the predetermined regions comprising the active material soften or stiffen, thereby enabling control of macroscopic properties of the lattice structure. As described above, the stimulus may be a higher or lower temperature, a higher or lower intensity of light, a higher or lower amount of moisture, and/or an applied stress at an increased or a reduced strain rate. In an example where the active material has a glass transition temperature lower than that of the passive material, 3D printing may be followed by heating the lattice structure to a temperature between the glass transition temperatures of the active and passive materials, such that the predetermined regions comprising the active material soften and are deactivated. In some examples, the temperature between the glass transition temperatures may lie in a range from about 80° C. to about 100° C.

Polymers and other materials having properties suitable for printing and for use as the active and passive materials have been identified, as indicated above. In one example, the active and passive materials may comprise polyethylene terephthalate (PET) and polycarbonate (PC), respectively. The temperature ranges suggested above may be particularly well-suited to usage of these active and passive materials.

In demonstration experiments, single and multimaterial lattice structures are printed with a nozzle diameter of 0.4 mm using a commercially available FDM apparatus (Ultimaker, S5 Utrecht, Netherlands). The height of the first layer is set at 0.1 mm, while the height of all subsequent layers is set at 0.3 mm with an infill density of 100%. The print speed is 50 mm/s with a retraction distance of 3 mm for both active and passive materials. To print a lattice structure comprising modified PET, which is obtained commercially from Taulman3D of Indianapolis, IN, the nozzle temperature is set to 250° C., the heated glass substrate is held at 45° C., the flow is set to 105%, and the fan speed is set to 40%. To print a lattice structure comprising polycarbonate, which is obtained commercially from Ultimaker of Utrecht, Netherlands, the nozzle temperature is set to 270° C., the heated glass substrate is held at 110° C., and the fan speed is set to 0%. When co-printing these materials, the PC is printed after the PET due to its higher glass transition temperature to ensure bonding. In these examples, the heated glass substrate is set to 80° C.

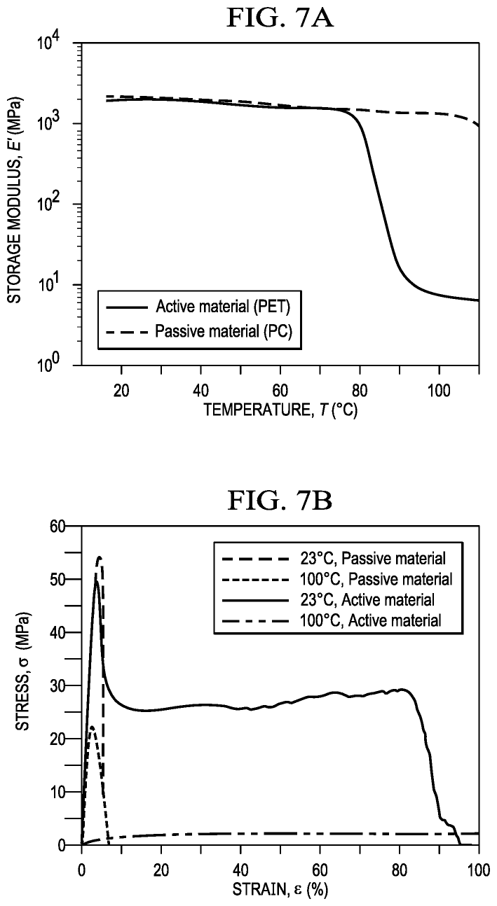

To characterize the mechanical response of PET and PC as a function of temperature, dynamic mechanical analysis (DMA) is carried out. Under ambient conditions (e.g., T=23° C.), the two materials exhibit virtually identical storage moduli of E_{PET}=2200 MPa and E_{PC}=2020 MPa, as desired. When the temperature is increased to T=100° C., E_{PET} is vastly reduced to 6.7 MPa, while E_{PC} is only slightly reduced to 1550 MPa, giving rise to more than two orders of magnitude difference in stiffness, as shown in FIG. 7A. These changes reflect differences between the glass transition temperatures of each material, where T_{gPET}=77° C. and T_{gPC}=112° C. To characterize their response beyond the linear-elastic regime, uniaxial tensile tests are carried out on pure PET and PC dogbone specimens. These data reveal that the elastic moduli of the two materials are quite similar, E_{PET}=2112 MPa and E_{PC}=1974 MPa, at T=23° C.; however, there is a dramatic decrease in E_{PET} to 8.2 MPa, while E_{PC} remains nearly the same at 1506 MPa at T=100° C., as shown in FIG. 7B. Moreover, PC displays a brittle to plastic behavior at both T=23° C. and at T=100° C., with a stress that decreases sharply beyond the yield point. By contrast, PET deforms plastically and fails at 90% strain at T=23° C. and shows a rubbery behavior with no distinct stress peaks at T=100° C.

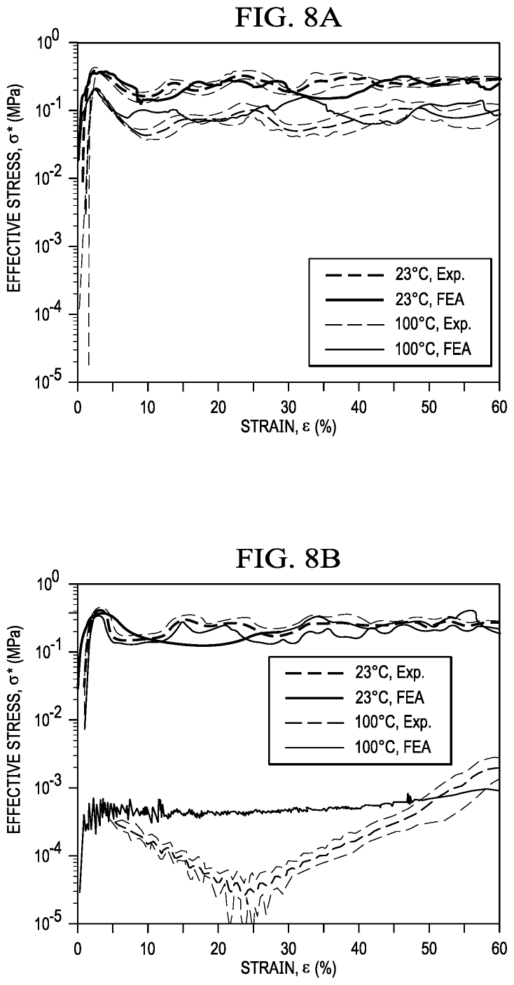

Pure PET and PC lattices are created via fused deposition modeling (FDM). Although the approach can be applied to any lattice geometry, lattices comprising of an array of six by six triangular unit cells are generated. All struts of each lattice structure are made either out of the active material or the passive material, have in-plane thickness t=0.5 mm, length l=12 mm, aspect ratio l/t=24, and out-of-plane thickness T (or w)=12 mm. Compression tests are carried out using a temperature-controlled environmental chamber. Referring to FIGS. 8A and 8B, the deformation of the passive and active lattices, respectively, is nearly identical at room temperature (e.g., T=23° C.) and is dominated by two regimes: a linear elastic region followed by a plateau as expected for stretching dominated lattices. By contrast, when the temperature is increased to T=100° C., the response of the passive lattice remains almost unaltered (FIG. 8A), while both the initial Young's modulus and stress plateau of the active lattice are substantially reduced (FIG. 8B). Note that out-of-plane buckling occurs in all samples of the purely active material tested at high temperature due to the significant softening, causing the plateau to temporarily drop upon plastic deformation.

To complement these experiments, non-linear finite element analysis (FEA) simulations are undertaken, in which plane-strain conditions are assumed, the models are discretized with 3-node quadratic beam elements, and a linearly elastic-perfectly plastic material model is used with temperature-dependent properties as provided in Table 1. The models are loaded by imposing a displacement to the top surface (bottom surface remains fixed) and the quasi-static response is simulated via the explicit dynamic algorithm. The good agreement between experiment and simulation, as revealed in FIGS. 8A and 8B, indicates that the FE analyses can be utilized to rapidly explore the vast design space available for lattice structures that integrate both active and passive materials.

TABLE 1
Mechanical Properties of PET and PC at 23° C. and 100° C.

| | Material | | | |
|---|---|---|---|---|
| | PET | PET | PC | PC |
| | Temperature (° C.) | | | |
| | 23 | 100 | 23 | 100 |
| Density (g/cm³) | 1.38 | 1.38 | 1.22 | 1.22 |
| Poisson's ratio | 0.33 | 0.33 | 0.33 | 0.33 |
| Elastic modulus (MPa) | 2,112 | 8.2 | 1,974 | 1,506 |
| Yield strength (MPa) | 49.6 | 1.66 | 54.2 | 19.2 |
| Yield strain | 0.044 | 2.53 | 3.8 | 2.67 |

Single-material lattices can either globally soften or maintain the mechanical properties upon an increase in temperature, as described above. By creating multimaterial lattices with spatially controlled distributions of the passive and active materials, it is possible to program vastly different mechanical responses at high temperature without altering their behavior under ambient conditions. To achieve this goal, it is beneficial to achieve good bonding between these materials during 3D printing or FDM. Exemplary triangular lattices are prepared by first printing PET and then printing PC, due to its higher T_{g}, as described above.

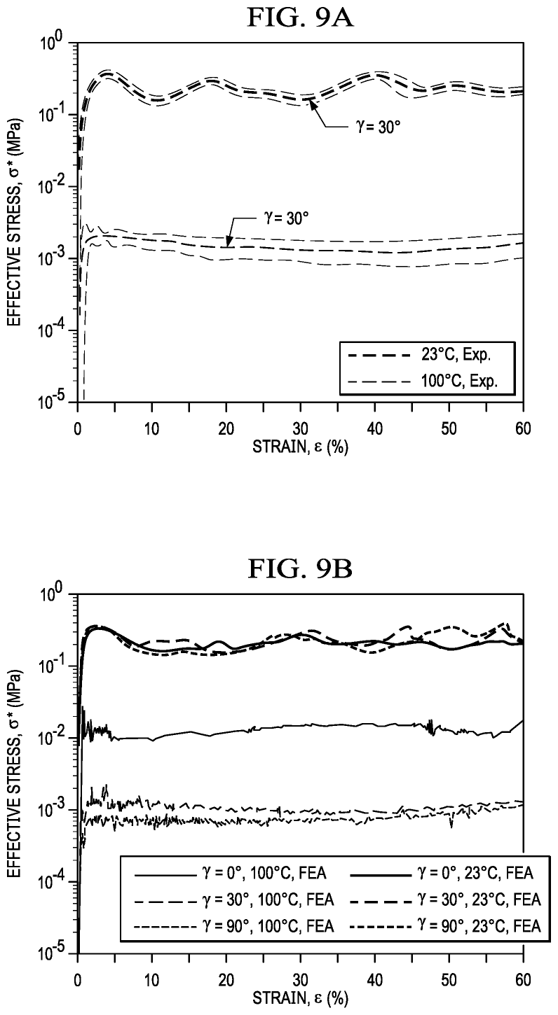

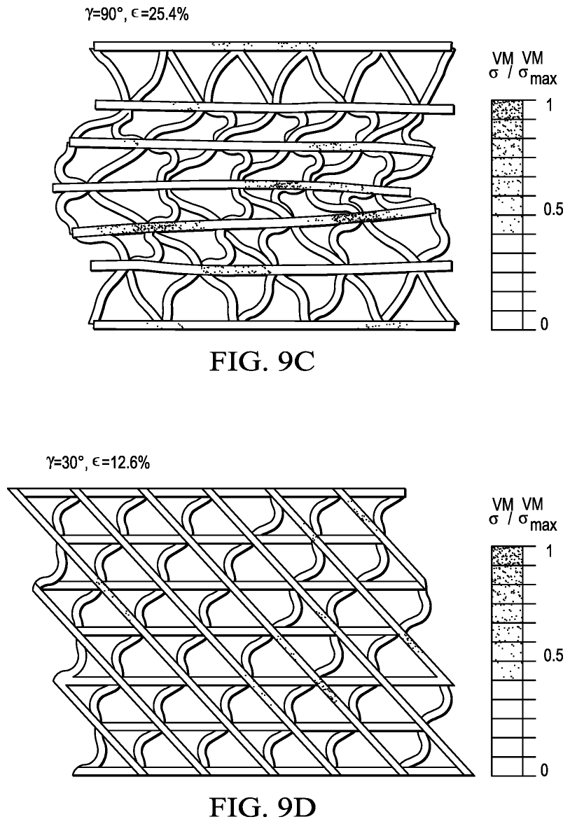

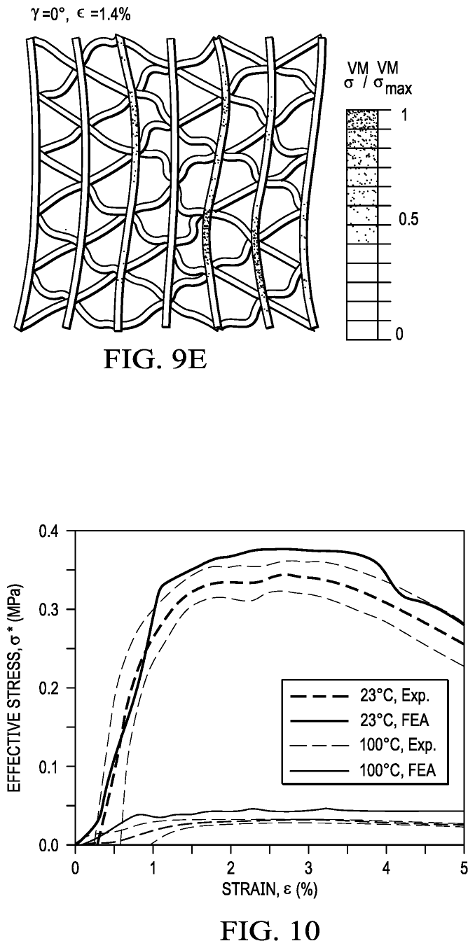

As a first example, multimaterial lattice structures are generated in which the initial structure is programmed to switch from virtually isotropic behavior under ambient conditions to highly anisotropic behavior at high temperature. This may be achieved by integrating struts 112 comprising the passive material 106 that are oriented at an angle γ with respect to the loading direction, as shown in FIG. 3B. FE analyses are used to investigate the effect of load directions on the response of these lattice structures 102 during uniaxial compression at both ambient and elevated temperatures, and representative experimental measurements are carried out for γ=30°. Referring to FIGS. 9A and 9B, at T=23° C., the stress-strain response of the lattice structure 102 is found to be is almost identical for γ=0°, 30°, and 90°, indicating an isotropic behavior. However, at high temperature, where about two-thirds of the initial structure is deactivated, the stress plateau for γ=0° is more than an order of magnitude higher than that observed for γ=30°, and 90°. These observations arise due to the alignment of the load with the struts comprising the passive material, which act as stiff columns despite their global buckling—a behavior that can be actively controlled by distributing the material and by considering intermediate temperature levels. Importantly, the numerical results are confirmed by experiment for γ=30°, where the measured stress plateau decreases from about 3×10⁻¹ MPa at T=23° C. to about 1.1×10⁻³ MPa at T=100° C. The numerically predicted deformation of these lattice structures for γ=0°, 30°, and at T=100° C. illustrated in FIGS. 9C-9E.

This paradigm also enables the realization of multimaterial lattice structures with programmable stiffness and strength by varying their effective relative density as a function of temperature. To demonstrate this, lattice structures comprising triangular cells with edge length l*=2l are printed with the passive material, and struts inside these cells comprise the active material, as shown in FIG. 2A. Since the relative density of a triangular lattice is given by

$$\overline{ρ} = 2 \sqrt{3} ( 1 - β ) ( \frac{t}{{l}^{*}} ) , \qquad ( 1 )$$

where β=0 denotes the porosity of the struts, these lattice structures are expected to have a relative density of 0.144 at T=23° C. and a relative density of at T=100° C. (as l*=l and 2l at T=23° C. and T=100° C., respectively). Further, since the (effective) modulus in such open-cell lattices, E*, has been shown to vary as

E*˜ρ⁻² (2)

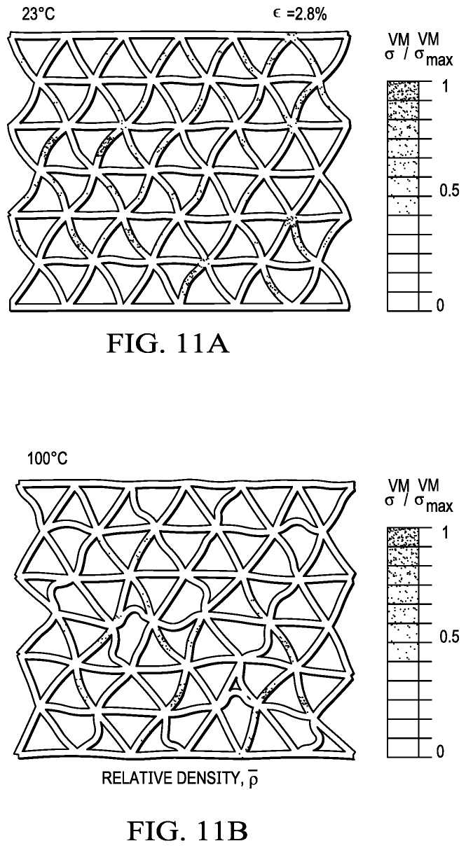

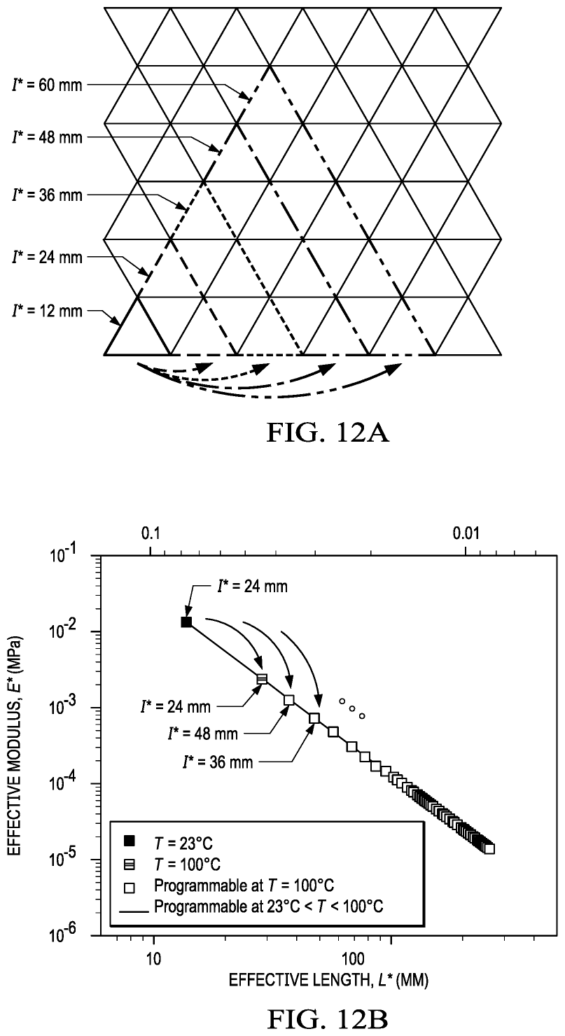

It is expected that E*=42.56 MPa at T=23° C. and E*=10.64 MPa at T=100° C. Importantly, the experiments and FE simulations reveal that E*=41.24 and 44.52 MPa at T=23° C. and E*=4.92 and 6.28 MPa at T=100° C., respectively, confirming the large tunability of their Young's modulus, as illustrated in FIG. 10. Referring to FIGS. 11A and 11b, The FE simulations also show that, while the stress distribution is relatively homogeneous across both the active and passive materials at T=23° C., the stress in the struts comprising the active material is negligible at T=100° C., confirming that an effective change in the relative density has been achieved. Unlike prior work, in which each temperature corresponds to a specific effective modulus of the lattice structure, it is possible to program different E* at a fixed high temperature by varying the edge length of the triangular cells made out of the passive material, as shown by the schematic of FIG. 12A. Specifically, if l*=nl (with n being an integer) is chosen, one obtains a relative density of 0.144 at low temperature and a relative density of 0.144/n at elevated temperature. As a consequence of equation (2), it is expected that E*=42.56 at T=23° C. and E*=42.56/2n at T=100° C. Simply by varying the number of struts defining the passive triangular cells, lattice structures 102 capable of achieving a discrete set of effective Young's moduli at T=100° C. while retaining their mechanical properties under ambient conditions can be realized, as demonstrated in FIG. 12B.

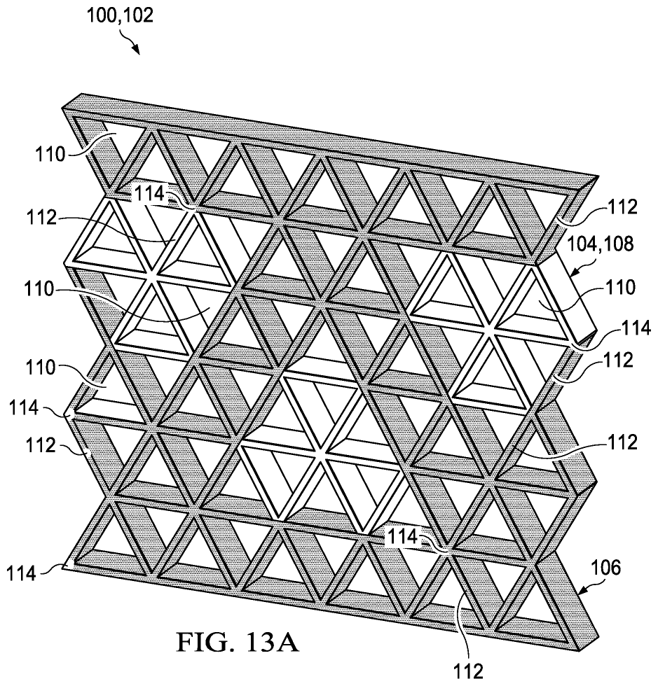

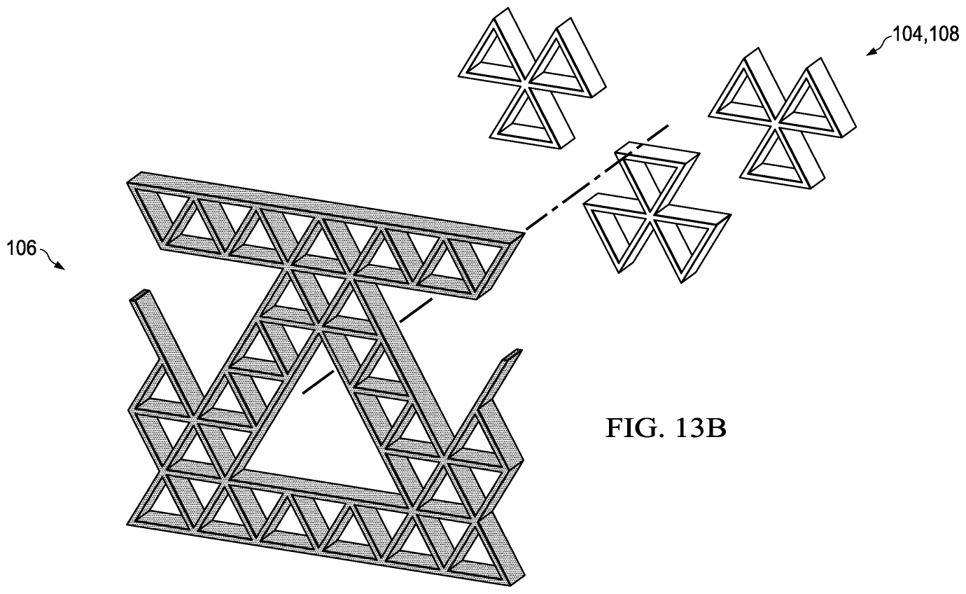

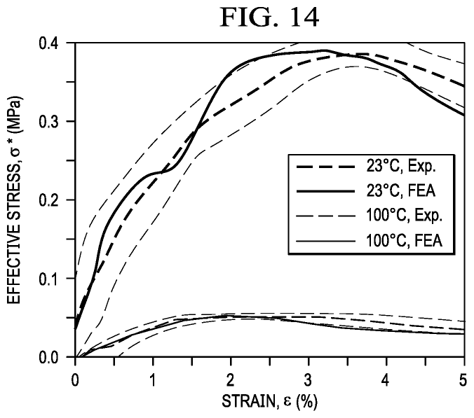

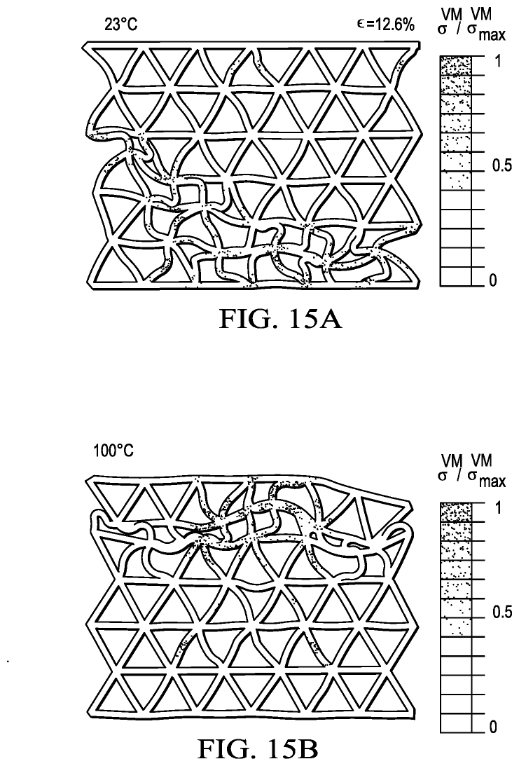

The lattice structure is not limited to discrete values of E*at elevated temperature, as the Young's modulus can be further programmed by controlling the effective strut thickness of the passive triangular cells, thus giving rise to hierarchical architectures. As an exemplar, a multimaterial lattice with the passive material arranged in triangular cells having an edge length l*=5l and effective strut thickness t sin(π/3)l is illustrated in FIGS. 13A and 13B. For such architectures, (1−β)=0.144 and Equations (1) and (2) predict that their density and Young's modulus remains the same at T=23° C. (i.e., relative density of 0.144 and E*=42.56), yet changes to a relative density of 0.087 and E*=15.32 MPa at T=100° C. Both experiments and FE simulations confirm the large tunability of the elastic modulus with measured values of E*=39.30 and 44.52 MPa at T=23° C. and E*=3.73 and 4.78 MPa at T=100° C., respectively, as shown in FIG. 14. Moreover, numerical snapshots indicate that the failure behavior of these hierarchical architectures vary with temperature. Under ambient conditions, these architected multimaterial lattices fail layer by layer, as revealed in FIG. 15A. By contrast, at T=100° C., the active material experiences little stress and the structure fails at the narrowest cross-section of the triangular unit cells comprising the passive material, as shown in FIG. 15B.

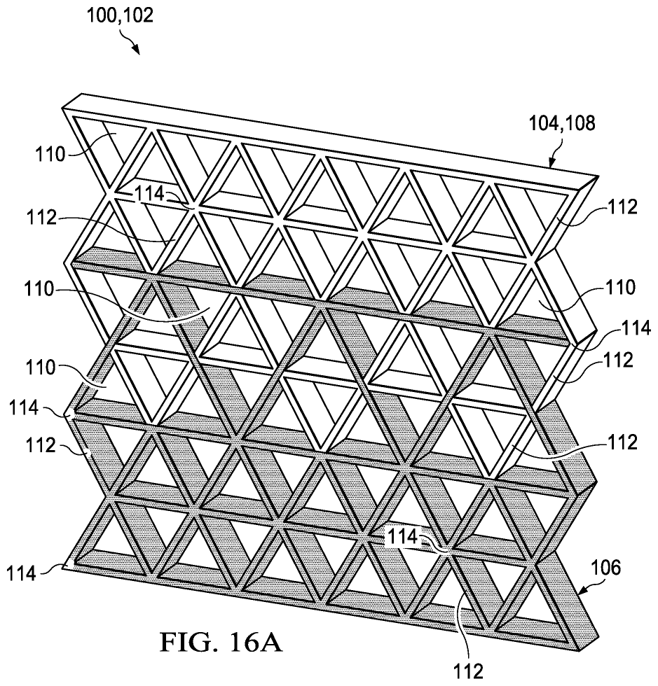

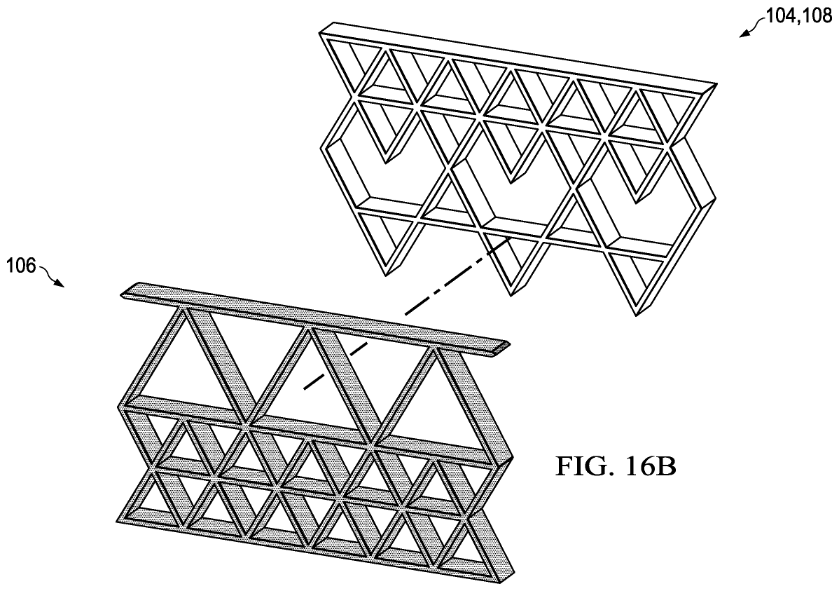

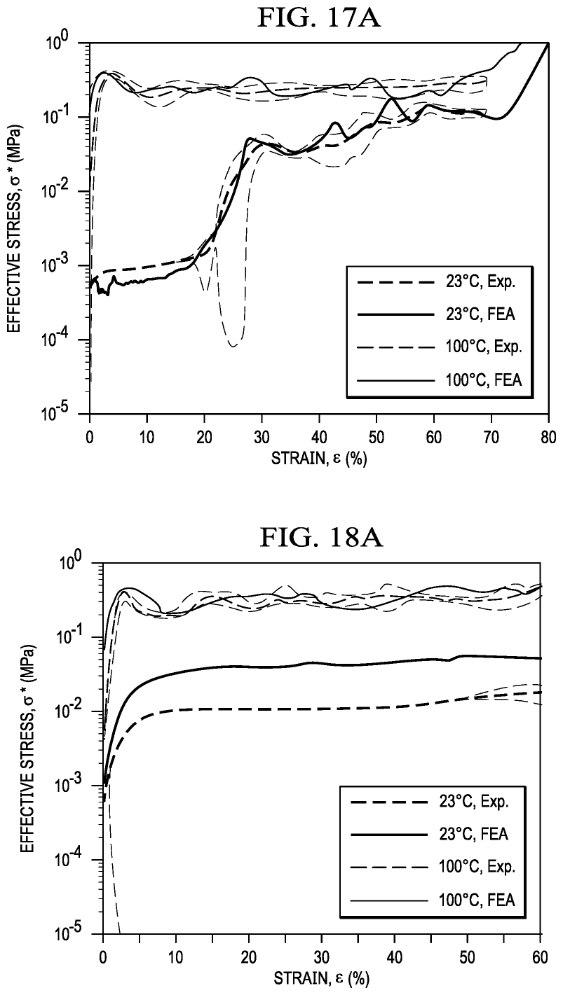

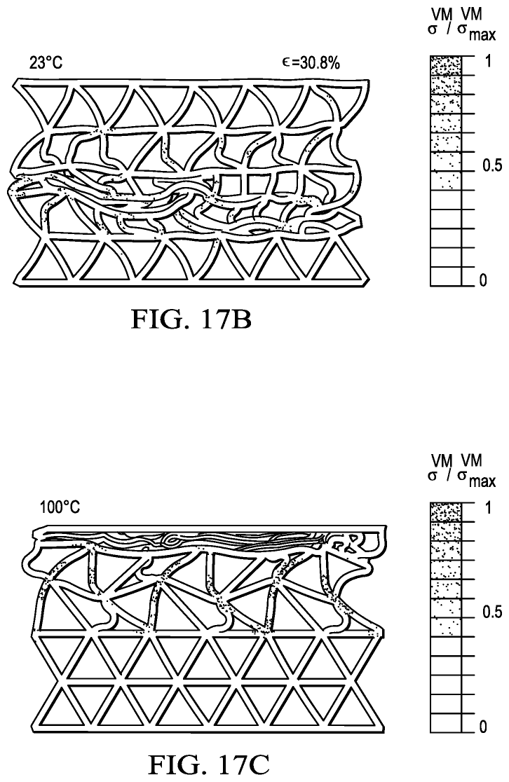

This approach can also be harnessed to realize architected multimaterial lattices with a target stress-strain response at elevated temperature. As an example, a lattice structure 102 can be designed that exhibits an initial linear behavior at T=100° C. followed by three distinct plateau regions by printing only passive material in the bottom struts, only active material in the top struts, and a combination of both materials in the central region, as shown in FIG. 16A. Referring to FIGS. 17A-17C, at T=100° C., the top (active material) region is the first to deform plastically, introducing a plateau at ˜3×10⁻⁴ MPa—a value comparable to that displayed by the lattice structure comprising only the active material. The central region starts to buckle and plastically deform once the top section is fully compacted, which leads to a second plateau at ˜4×10⁻¹ MPa. Finally, at ε˜0.5, the central region is fully solidified and the deformation is transmitted to the bottom region, which enters the plastic regime via local buckling, leading to the formation of a third plateau at ˜1×10⁻¹ MPa.

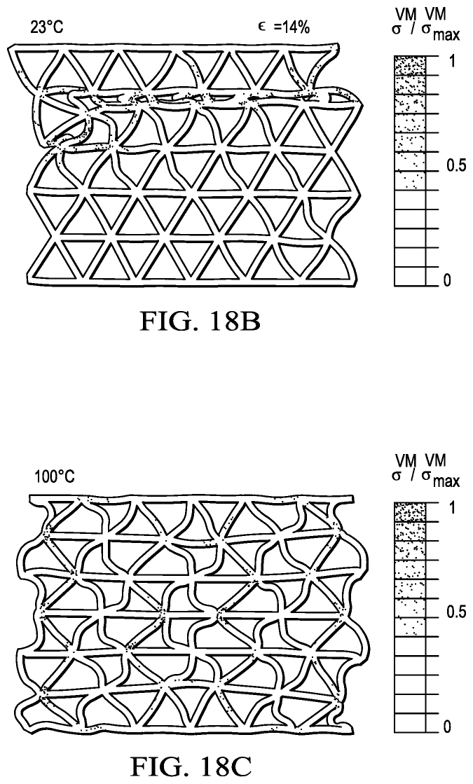

An exemplary lattice structure whose deformation is dominated by stretching at ambient temperature and by bending at higher temperatures is illustrated in FIGS. 1A and 1B. As explained above, this change in deformation mode from stretching-dominated to bending-dominated may depend on the connectivity number, Z, where for Z≥6, two-dimensional lattice structures may be stretching dominated, and for Z≥3, they may be bending-dominated. At T=23° C., all struts have similar mechanical properties, Z=6, and the stress-strain curve displays a high initial peak stress followed by several bumps indicative of a layer by layer failure, as shown in FIG. 18A. Such behavior is typical of stretching-dominated lattices and known to be advantageous for structural applications that require high stiffness and strength. By contrast, at T=100° C., the connectivity reduces to Z=3 due to the deactivation of the active struts, mechanically revealing the effective hexagonal lattice structure. The resulting stress-strain behavior lacks any distinct peaks and the stress plateaus remain relatively constant until densification at ε>60%—a behavior typical of bending—dominated structures. FIGS. 18B and 18C illustrate the numerically predicted deformation at 23° C. and 100° C., respectively, for ε=14%.

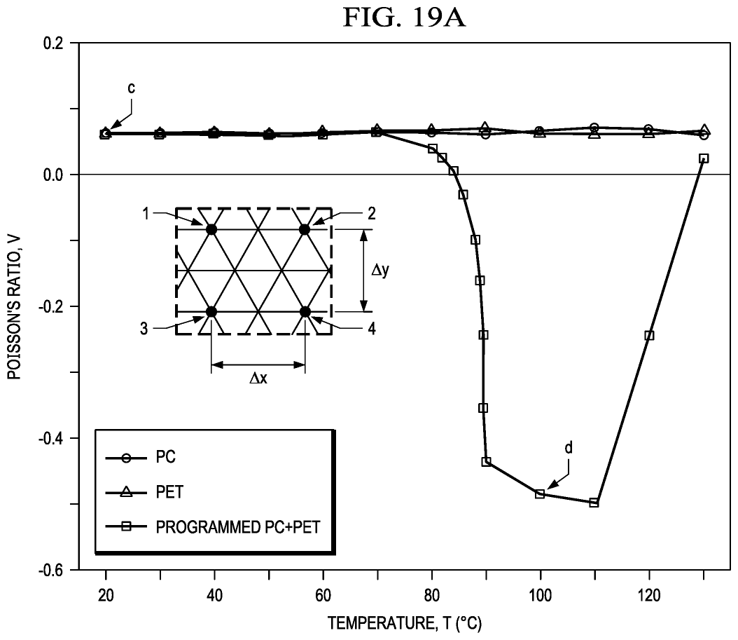

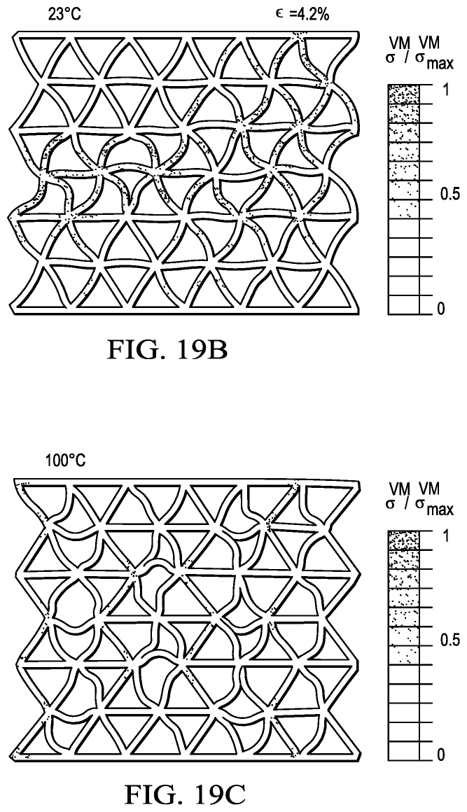

As a final demonstration, it is shown that a tunable Poisson's ratio can be achieved by realizing a re-entrant multimaterial lattice architecture that typically possesses negative Poisson's ratio. At ambient temperature, this lattice effectively behaves as a triangular lattice and displays a positive Poisson's ratio, v=0.063, as shown in FIG. 4A. However, as the temperature is increased, the active material eventually softens and exposes the re-entrant lattice defined by the passive material, as shown in FIG. 4B. At T=100° C., the Poisson's ratio sharply decreases to v=−0.48. Note that the Poisson's ratios reported in FIG. 19A are extracted from FE simulations at ε=0.01 and averaged over four nodes in the central part of the structure. FIGS. 19B and 19C shown numerically predicted deformation for ε=4.2% at T=23° C. (c) and T=100° C., respectively.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to a programmable metamaterial comprising: a lattice structure comprising an active material and a passive material and including interconnected struts, the active material having a glass transition temperature lower than that of the passive material, wherein the active material is disposed at predetermined regions of the lattice structure to enable softening and deactivation of the predetermined regions upon exposure to a temperature between the glass transition temperatures of the active and passive materials, thereby enabling control over macroscopic properties of the lattice structure.

A second aspect relates to the programmable metamaterial of the first aspect, wherein each strut is formed from one or more printed filaments.

A third aspect relates to the programmable metamaterial of the first or second aspect, wherein, at room temperature: a storage modulus of the active material differs from a storage modulus of the passive material by no more than +/−10%, an elastic modulus of the active material differs from an elastic modulus of the passive material by no more than +/−10%, a yield strength of the active material differs from a yield strength of the passive material by no more than +/−10%, and/or a failure strength of the active material differs from a failure strength of the passive material by no more than +/−10%.

A fourth aspect relates to the programmable metamaterial of any preceding aspect, wherein, at the temperature between the glass transition temperatures of the active and passive materials, a difference between a storage modulus of the active material and a storage modulus of the passive material is a maximum.

A fifth aspect relates to the programmable metamaterial of any preceding aspect, wherein, at the temperature between the glass transition temperatures of the active and passive materials, a storage modulus of the passive material is at least one order of magnitude, at least 1.5 orders of magnitude, and/or at least two orders of magnitude greater than a storage modulus of the active material.

A sixth aspect relates to the programmable metamaterial of any preceding aspect, wherein, at a second temperature higher than the glass transition temperatures of the active and passive materials, a storage modulus of the active material is higher than that of the passive material.

A seventh aspect relates to the programmable metamaterial of any preceding aspect, wherein the lattice structure comprises voids between the struts, the lattice structure being a porous structure.

An eighth aspect relates to the programmable metamaterial of any preceding aspect, wherein the lattice structure does not comprise voids between the struts, the lattice structure being a solid structure.

A ninth aspect relates to the programmable metamaterial of any preceding aspect, wherein the lattice structure is formed from multiple layers of printed filaments, the multiple layers defining a thickness of the lattice structure.

A tenth aspect relates to the programmable metamaterial of any preceding aspect, wherein the lattice structure, when viewed along a plane perpendicular to a thickness direction, comprises a 2D lattice selected from the group consisting of: triangular lattice, square lattice, hexagonal lattice, rectangular lattice, and oblique lattice.

An eleventh aspect relates to the programmable metamaterial of any preceding aspect, wherein the lattice structure comprises a 3D lattice.

A twelfth aspect relates to the programmable metamaterial of any preceding aspect, wherein each of the active material and the passive material comprises a polymer, such as a thermoplastic polymer.

A thirteenth aspect relates to the programmable metamaterial of any preceding aspect, wherein the passive and active materials comprise a polymer selected from the group consisting of: polyethylene terephthalate (PET), glycol-modified polyethylene terephthalate (PETG), polylactic acid (PLA), chlorinated polyethylene (CPE), polycarbonate (PC), and copolyester.

A fourteenth aspect relates to the programmable metamaterial of any preceding aspect, wherein the passive material comprises polycarbonate (PC) and the active material comprises polyethylene terephthalate (PET).

A fifteenth aspect relates to the programmable metamaterial of any preceding aspect, wherein the active material and the passive material are capable of adhering to each other.

A sixteenth aspect relates to the programmable metamaterial of any preceding aspect, wherein the predetermined regions of the lattice structure comprise struts, portions of struts, and/or nodes.

A seventeenth aspect relates to the programmable metamaterial of any preceding aspect, wherein the lattice structure comprises a first unit cell size at room temperature and a second effective unit cell size at the temperature between the glass transition temperatures due to the softening and deactivation of the predetermined regions.

An eighteenth aspect relates to the programmable metamaterial of any preceding aspect, wherein the lattice structure comprises isotropic properties at room temperature and anisotropic properties at the temperature between the glass transition temperatures due to the softening and deactivation of the predetermined regions.

A nineteenth aspect relates to the programmable metamaterial of any preceding aspect, wherein the lattice structure comprises a positive Poisson's ratio at room temperature and a negative Poisson's ratio at the temperature between the glass transition temperatures due to the softening and deactivation of the predetermined regions.

A twentieth aspect relates to the programmable metamaterial of any preceding aspect, wherein the lattice structure comprises spatially uniform properties at room temperature and a gradient in properties at the temperature between the glass transition temperatures due to the softening and deactivation of the predetermined regions.

A twenty-first aspect relates to the programmable metamaterial of any preceding aspect, wherein the lattice structure comprises spatially uniform properties at room temperature and spatially nonuniform properties at the temperature between the glass transition temperatures due to the softening and deactivation of the predetermined regions.

A twenty-second aspect relates to the programmable metamaterial of any preceding aspect, wherein the lattice structure comprises a first deformation mode at room temperature and a second deformation mode at the temperature between the glass transition temperatures due to the softening and deactivation of the predetermined regions.

A twenty-third aspect relates to the programmable metamaterial of any preceding aspect, wherein the first deformation mode is a stretching-dominated deformation mode and the second deformation mode is a bending-dominated deformation mode.

A twenty-fourth aspect relates to the programmable metamaterial of any preceding aspect, wherein the active material and/or the passive material includes filler particles configured to alter the electrical, optical, magnetic and/or mechanical properties of the lattice structure.

A twenty-fifth aspect relates to the programmable metamaterial of any preceding aspect, the programmable metamaterial being formed by 3D printing, e.g., as set forth in any of the following aspects relating to a method of controlling macroscopic properties of a metamaterial.

A twenty-sixth aspect relates to a method of controlling macroscopic properties of a metamaterial, the method comprising: 3D printing a lattice structure comprising interconnected struts, each strut comprising one or more printed filaments, each printed filament comprising an active material or a passive material, the active material having a glass transition temperature lower than that of the passive material, the printed filaments comprising the active material being disposed at predetermined regions of the lattice structure; after 3D printing, heating the lattice structure to a temperature between the glass transition temperatures of the active and passive materials, whereby the predetermined regions comprising the active material soften and are deactivated, thereby enabling thermal control of macroscopic properties of the lattice structure.

A twenty-seventh aspect relates to the method of the twenty-sixth aspect, wherein the 3D printing comprises extruding and depositing the printed filaments.

A twenty-eighth aspect relates to the method of the twenty-sixth or twenty-seventh aspect, wherein the 3D printing comprises depositing multiple layers of the printed filaments, the multiple layers defining a thickness of the lattice structure.

A twenty-ninth aspect relates to the method of any of the twenty-sixth through the twenty-eighth aspects, wherein, during 3D printing of each layer, the printed filaments comprising the active material are extruded and deposited prior to the printed filaments comprising the passive material.

A thirtieth aspect relates to the method of any of the twenty-sixth through the twenty-ninth aspects, wherein the 3D printing is carried out at a printing temperature above the glass transition temperatures of the active and passive materials using a printing feedstock comprising a solid polymer, followed by cooling to room temperature.

A thirty-first aspect relates to the method of any of the twenty-sixth through the thirtieth aspects, wherein the 3D printing is carried out at room temperature (e.g., 20-25° C.) using a printing ink comprising a polymer dissolved in a solvent, followed by evaporation of the solvent.

A thirty-second aspect relates to the method of any of the twenty-sixth through the thirty-first aspects, wherein the temperature to which the lattice structure is heated after 3D printing is in a range from about 80° C. to about 100° C.

A thirty-third aspect relates to the method of any of the twenty-sixth through the thirty-second aspects, wherein the predetermined regions of the lattice structure comprise struts, portions of struts, and/or nodes.

A thirty-fourth aspect relates to the method of any of the twenty-sixth through the thirty-third aspects, wherein the active material, the passive material, and the lattice structure include any or all of the features recited in claims 1-24.

A thirty-fifth aspect relates to a programmable metamaterial comprising: a lattice structure comprising an active material and a passive material and including interconnected struts, the active material having a modulus with a higher stimulus dependence than that of the passive material, wherein the active material is disposed at predetermined regions of the lattice structure to enable softening or stiffening of the predetermined regions upon exposure to a stimulus, thereby enabling control over macroscopic properties of the lattice structure.

A thirty-sixth aspect relates to the programmable metamaterial of the thirty-fifth aspect, wherein the stimulus is selected from the group consisting of: a higher or lower temperature, a higher or lower intensity of light, a higher or lower amount of moisture, and an applied stress at an increased or a reduced strain rate.

A thirty-seventh aspect relates to the programmable metamaterial of the thirty-fifth or the thirty-sixth aspect, wherein the lattice structure comprises voids between the struts, the lattice structure being a porous structure.

A thirty-eighth aspect relates to the programmable metamaterial of any of the thirty-fifth through the thirty-seventh aspects, wherein the lattice structure does not comprise voids between the struts, the lattice structure being a solid structure.

A thirty-ninth aspect relates to the programmable metamaterial of any of the thirty-fifth through the thirty-eighth aspects, wherein the lattice structure is formed from multiple layers of printed filaments, the multiple layers defining a thickness of the lattice structure.

A fortieth aspect relates to the programmable metamaterial of any of the thirty-fifth through the thirty-ninth aspects, wherein the lattice structure, when viewed along a plane perpendicular to a thickness direction, comprises a 2D lattice selected from the group consisting of: triangular lattice, square lattice, hexagonal lattice, rectangular lattice, and oblique lattice.

A forty-first aspect relates to the programmable metamaterial of any of the thirty-fifth through the fortieth aspects, wherein the lattice structure comprises a 3D lattice.

A forty-second aspect relates to the programmable metamaterial of any of the thirty-fifth through the forty-first aspects, wherein each of the active material and the passive material comprises a polymer, metal, ceramic and/or semiconductor.

A forty-third aspect relates to the programmable metamaterial of any of the thirty-fifth through the forty-second aspects, wherein the passive and active materials comprise a polymer selected from the group consisting of: polyethylene terephthalate (PET), glycol-modified polyethylene terephthalate (PETG), polylactic acid (PLA), chlorinated polyethylene (CPE), polycarbonate (PC), and copolyester.

A forty-fourth aspect relates to the programmable metamaterial of any of the thirty-fifth through the forty-third aspects, wherein the passive material comprises polycarbonate (PC) and the active material comprises polyethylene terephthalate (PET).

A forty-fifth aspect relates to the programmable metamaterial of any of the thirty-fifth through the forty-fourth aspects, wherein the active material and the passive material are capable of adhering to each other.

A forty-sixth aspect relates to the programmable metamaterial of any of the thirty-fifth through the forty-fifth aspects, wherein the predetermined regions of the lattice structure comprise struts, portions of struts, and/or nodes.

A forty-seventh aspect relates to the programmable metamaterial of any of the thirty-fifth through the forty-sixth aspects, wherein the lattice structure comprises a first unit cell size at an initial condition and a second effective unit cell size upon exposure to the stimulus due to the softening or stiffening of the predetermined regions.

A forty-eighth aspect relates to the programmable metamaterial of any of the thirty-fifth through the forty-seventh aspects, wherein the lattice structure comprises isotropic properties at an initial condition and anisotropic properties upon exposure to the stimulus due to the softening or stiffening of the predetermined regions.

A forty-ninth aspect relates to the programmable metamaterial of any of the thirty-fifth through the forty-eighth aspects, wherein the lattice structure comprises a positive Poisson's ratio at an initial condition and a negative Poisson's ratio upon exposure to the stimulus due to the softening or stiffening of the predetermined regions.

A fiftieth aspect relates to the programmable metamaterial of any of the thirty-fifth through the forty-ninth aspects, wherein the lattice structure comprises spatially uniform properties at an initial condition and a gradient in properties upon exposure to the stimulus due to the softening or stiffening of the predetermined regions.

A fifty-first aspect relates to the programmable metamaterial of any of the thirty-fifth through the fiftieth aspects, wherein the lattice structure comprises spatially uniform properties at an initial condition and spatially nonuniform properties upon exposure to the stimulus due to the softening or stiffening of the predetermined regions.

A fifty-second aspect relates to the programmable metamaterial of any of the thirty-fifth through the fifty-first aspects, wherein the lattice structure comprises a first deformation mode at an initial condition and a second deformation mode upon exposure to the stimulus due to the softening or stiffening of the predetermined regions.

A fifty-third aspect relates to the programmable metamaterial of any of the thirty-fifth through the fifty-second aspects, wherein the first deformation mode is a stretching-dominated deformation mode and the second deformation mode is a bending-dominated deformation mode.

A fifty-fourth aspect relates to the programmable metamaterial of any of the thirty-fifth through the fifty-third aspects, wherein the active material and/or the passive material includes filler particles configured to alter the electrical, optical, magnetic and/or mechanical properties of the lattice structure.

A fifty-fifth aspect relates to the programmable metamaterial of any one of of the thirty-fifth through the fifty-fourth aspects, the programmable metamaterial being formed by 3D printing, e.g., as set forth in any following aspect.

A fifty-sixth aspect relates to a method of controlling macroscopic properties of a metamaterial, the method comprising: 3D printing a lattice structure comprising interconnected struts, each strut comprising one or more printed filaments, each printed filament comprising an active material or a passive material, the active material having a modulus with a higher stimulus dependence than that of the passive material, the printed filaments comprising the active material being disposed at predetermined regions of the lattice structure; and after 3D printing, exposing the lattice structure to a stimulus, whereby the predetermined regions comprising the active material soften or stiffen, thereby enabling control of macroscopic properties of the lattice structure.

A fifty-seventh aspect relates to the method of the fifty-sixth aspect, wherein the stimulus is selected from the group consisting of: a higher or lower temperature, a higher or lower intensity of light, a higher or lower amount of moisture, and an applied stress at an increased or a reduced strain rate.

A fifty-eighth aspect relates to the method of the fifty-sixth or the fifty-seventh aspect, wherein the 3D printing comprises extruding and depositing the printed filaments.

A fifty-ninth aspect relates to the method of any of the fifty-sixth through the fifty-eighth aspects, wherein the 3D printing comprises depositing multiple layers of the printed filaments, the multiple layers defining a thickness of the lattice structure.

A sixtieth aspect relates to the method of any of the fifty-sixth through the fifty-ninth aspects, wherein, during 3D printing of each layer, the printed filaments comprising the active material are extruded and deposited prior to the printed filaments comprising the passive material.

A sixty-first aspect relates to the method of any of the fifty-sixth through the sixtieth aspects, wherein the 3D printing is carried out at an elevated temperature using a printing feedstock comprising a solid polymer, followed by cooling to room temperature.

A sixty-second aspect relates to the method of any of the fifty-sixth through the sixty-first aspects, wherein the 3D printing is carried out at room temperature (e.g., 20-25° C.) using a printing ink comprising a precursor material dissolved in a solvent, followed by evaporation of the solvent.

A sixty-third aspect relates to the method of any of the fifty-sixth through the sixty-second aspects, wherein the temperature to which the lattice structure is heated after 3D printing is in a range from about 80° C. to about 100° C.

A sixty-fourth aspect relates to the method of any of the fifty-sixth through the sixty-third aspects, wherein the predetermined regions of the lattice structure comprise struts, portions of struts, and/or nodes.

A sixty-fifth aspect relates to the method of any of the fifty-sixth through the sixty-fourth aspects, wherein the active material, the passive material, and the lattice structure include any or all of the features recited in any of the thirty-fifth through the sixty-fourth aspects.

A sixty-sixth aspect relates to the programmable metamaterial or the method of any preceding aspect, wherein “modulus” may refer to an elastic modulus or a storage modulus, wherein “an active material having a modulus with a higher stimulus dependence than that of the passive material” may be understood to mean that the modulus of the active material exhibits a greater shift or change upon exposure to the stimulus compared to the modulus of the passive material, and wherein the modulus of the passive material may exhibit no shift or no change upon exposure to the stimulus, and/or wherein “at an initial condition” may be understood to be at room temperature or another initial temperature, in darkness or under an initial intensity of light, in a dry state or comprising an initial amount of moisture, under no applied stress or under an applied stress at an initial strain rate.

In addition to the features mentioned in each of the independent aspects enumerated above, some examples may show, alone or in combination, the optional features mentioned in the dependent aspects and/or as disclosed in the description above and shown in the figures.

1. A programmable metamaterial comprising:
a lattice structure comprising an active material and a passive material and including interconnected struts, the active material having a modulus with a higher stimulus dependence than that of the passive material,
wherein the active material is disposed at predetermined regions of the lattice structure to enable softening or stiffening of the predetermined regions upon exposure to a stimulus.

2. The programmable metamaterial of claim 1, wherein the stimulus is selected from the group consisting of: a higher or lower temperature, a higher or lower intensity of light, a higher or lower amount of moisture, and an applied stress at an increased or a reduced strain rate.

3. The programmable metamaterial of claim 1, wherein, when the lattice structure is exposed to the stimulus, a storage modulus of the passive material is at least one order of magnitude greater than a storage modulus of the active material.

4. The programmable metamaterial of claim 1, wherein, when the lattice structure is at an initial condition, a storage modulus of the active material differs from a storage modulus of the passive material by no more than +/−10%.

5. The programmable metamaterial of claim 1, wherein the passive and active materials comprise a polymer selected from the group consisting of: polyethylene terephthalate (PET), glycol-modified polyethylene terephthalate (PETG), polylactic acid (PLA), chlorinated polyethylene (CPE), polycarbonate (PC), and copolyester.

6. The programmable metamaterial of claim 1, wherein the active material has a glass transition temperature lower than that of the passive material.

7. The programmable metamaterial of claim 1, wherein the active material and/or the passive material include filler particles configured to alter the electrical, optical, magnetic and/or mechanical properties of the lattice structure.

8. The programmable metamaterial of claim 1, wherein the predetermined regions of the lattice structure comprise struts, portions of struts, and/or nodes.

9. The programmable metamaterial of claim 1, wherein the lattice structure, when viewed along a plane perpendicular to a thickness direction, comprises a 2D lattice selected from the group consisting of: triangular lattice, square lattice, hexagonal lattice, rectangular lattice, and oblique lattice.

10. A method of controlling macroscopic properties of a metamaterial, the method comprising:
3D printing a lattice structure comprising interconnected struts, each strut comprising one or more printed filaments, each printed filament comprising an active material or a passive material, the active material having a modulus with a higher stimulus dependence than that of the passive material, the printed filaments comprising the active material being disposed at predetermined regions of the lattice structure; and
after 3D printing, exposing the lattice structure to a stimulus, whereby the predetermined regions comprising the active material soften or stiffen, thereby enabling control of macroscopic properties of the lattice structure.

11. The method of claim 10, wherein the stimulus is selected from the group consisting of: a higher or lower temperature, a higher or lower intensity of light, a higher or lower amount of moisture, and an applied stress at an increased or a reduced strain rate.

12. The method of claim 10, wherein, prior to exposing the lattice structure to the stimulus, a storage modulus of the active material differs from a storage modulus of the passive material by no more than +/−10%.

13. The method of claim 10, wherein, upon exposing the lattice structure to the stimulus, a storage modulus of the passive material is at least one order of magnitude greater than a storage modulus of the active material.

14. The method of claim 10, wherein the active material has a glass transition temperature lower than that of the passive material, and wherein the stimulus comprises a higher temperature.

15. The method of claim 14, wherein exposing the lattice structure to the stimulus comprises heating the lattice structure to a temperature between the glass transition temperatures of the active and passive materials, whereby the predetermined regions comprising the active material soften.

16. The method of claim 10, wherein the passive and active materials comprise a polymer selected from the group consisting of: polyethylene terephthalate (PET), glycol-modified polyethylene terephthalate (PETG), polylactic acid (PLA), chlorinated polyethylene (CPE), polycarbonate (PC), and copolyester.

17. The method of claim 10, wherein the 3D printing comprises extruding and depositing the printed filaments, and
wherein multiple layers of the printed filaments define a thickness of the lattice structure.

18. The method of claim 10, wherein, within each layer, the printed filaments comprising the active material are extruded and deposited prior to the printed filaments comprising the passive material.

19. The method of claim 10, wherein the 3D printing is carried out at a printing temperature above glass transition temperatures of the active and passive materials using a printing feedstock comprising a solid polymer, followed by cooling to room temperature.

20. The method of claim 10, wherein the 3D printing is carried out at room temperature using a printing ink comprising a polymer dissolved in a solvent, followed by evaporation of the solvent.
